(19) United States
(12) Patent Application Publication
(10) Pub. No.: US 2026/0158306 A1
(43) Pub. Date: Jun. 11, 2026

(54) EMERGENCY ESCAPE SYSTEM FOR FIRE OR HAZARDOUS CONDITIONS

(71) Applicant: Mirza Faizan, Plano, TX (US)

(72) Inventors: Mirza Faizan, Plano, TX (US); Usman Khan, Plano, TX (US); Aroush Fatima, Patna (IN); Aarifa Fatima, Patna (IN); Niyantri Narayanan, Plano, TX (US); Omar Ismail, Plano, TX (US); Eyad Ismail, Plano, TX (US); Sarah Francis, Plano, TX (US); Ismail Mohammed Ali, Plano, TX (US); Advaita Piduri, Plano, TX (US); Hadiya Sameen, Plano, TX (US); Faiza Hoda Mallick, Plano, TX (US); Iliyan Ali Mithani, Plano, TX (US); Nithyashri Ramesh, Plano, TX (US)

(21) Appl. No.: 18/970,318

(22) Filed: Dec. 5, 2024

(51) Int. Cl. A62C 2/24; B66B 25/00; B66B 31/00

(52) U.S. Cl. CPC A62C 2/246; B66B 25/00; B66B 31/00

(57) ABSTRACT

An emergency escape system for deployment during fire or hazardous conditions is disclosed. The system comprises a tunnel assembly stored in a compact configuration within a recessed cavity beneath a floor during normal conditions, a hazard detection unit configured to detect a fire or hazardous condition, a deployment mechanism configured to unfold and deploy the tunnel assembly from the recessed cavity upon detection of the fire or hazardous condition, and a processor configured to activate the deployment mechanism based on the detection of the fire or hazardous condition, wherein the tunnel assembly, when deployed, forms an escape passage from a hazardous environment to a safe location.

### TECHNICAL FIELD

The present invention relates to an emergency escape system, more specifically to an emergency escape system for safely evacuating individuals during fire or other hazardous conditions that occur in buildings, industrial facilities, or other enclosed structures.

### BACKGROUND

A current fire escape system, which typically includes escape routes, ladders, slides, or specially designed exits in buildings, can present several challenges depending on its design and implementation. One major issue is the need for regular maintenance and inspections. If these systems, such as ladders or ropes, are neglected, they can degrade over time, making them unsafe during an emergency. Additionally, without frequent inspections, these systems may fail when needed most. Inaccessibility is another significant drawback, as escape routes can become blocked by furniture or debris, particularly in high-rise buildings. These systems are often difficult for the elderly, disabled, or young children to use, limiting their effectiveness for all building occupants.

Another challenge is the complexity or lack of familiarity with the system. Escape methods, such as deployable ladders or window-based exits, may require specific instructions that not everyone knows, especially under stress. Moreover, building occupants might not receive proper training on using these systems, particularly in high-turnover areas like offices or hotels. Design limitations also play a role, as some systems, especially rope or ladder-based escapes, are unsuitable for tall buildings. High-rise structures may require more complex evacuation methods, such as helicopters or external escape pods. Furthermore, space constraints can make it difficult to install effective escape systems, particularly in older or densely packed buildings, and external escape routes may expose evacuees to additional risks like smoke, heat, or falling debris.

Therefore, there is a need for an emergency escape system that automatically deploys during fire or hazardous conditions and provides a safe, reliable, and efficient route for occupants to exit the structure. This invention addresses above mentioned concerns.

### SUMMARY OF INVENTION

In an embodiment, an emergency escape system for deployment during a fire or hazardous conditions is disclosed. The emergency escape system comprises a tunnel assembly stored in a compact configuration within a recessed cavity beneath a floor during normal conditions, and a hazard detection unit configured to detect a fire or hazardous condition. The emergency escape system further comprises a deployment mechanism configured to unfold and deploy the tunnel assembly from the recessed cavity upon detection of the fire or hazardous condition. The emergency escape system further comprises a processor configured to activate the deployment mechanism based on the detection of the fire or hazardous condition, such that the tunnel assembly, when deployed, forms an escape passage from a hazardous environment to a safe location.

In an embodiment, the tunnel assembly is made up of several interlocking tunnel segments such that each tunnel segment of the plurality of interlocking tunnel segments is foldable upon itself to form a continuous tunnel when deployed, and each tunnel segment is interlocked to the corresponding adjacent tunnel segments of the plurality of interlocking tunnel segments.

In an embodiment, the deployment mechanism has one or more hydraulic actuators. These actuators are designed to push the tunnel segments outward from the recessed cavity and use guiding rails to control the path of the tunnel segments as they are deployed.

In an embodiment, the emergency escape system also includes a locking mechanism that keeps the tunnel assembly in a folded state during normal conditions. This locking mechanism is released when the deployment mechanism is activated.

In an embodiment, the hazard detection unit comprises a smoke detector or a combination of heat, fire, or gas detectors operable to detect hazardous conditions and configured to send a signal to the processor to activate the deployment mechanism. In an embodiment, the emergency escape system, further comprising a fire-suppressing cover positioned at an entrance of the tunnel, wherein the fire-suppressing cover is configured to extinguish any flames on individuals entering the tunnel by isolating the fire from oxygen and preventing the entry of burning objects into the tunnel.

In a further embodiment, the tunnel assembly includes fireproof and debris-resistant materials, configured to protect individuals from falling debris or heat while they are being transported through the tunnel.

In an embodiment, the emergency escape system further comprises a conveyor belt system within the tunnel to transport individuals to a safe location, wherein the conveyor belt is powered by an external motor and operable to transport both conscious and unconscious individuals.

In a further embodiment, the conveyor belt system includes triangular separators to prevent crowding within the tunnel and to control the flow of individuals during evacuation.

In an embodiment, the emergency escape system further comprises intumescent seals at the joints between tunnel segments. These seals expand when exposed to heat, creating an airtight and fire-resistant barrier at the joints.

In a further embodiment, the tunnel assembly includes extendable air tubes integrated into the tunnel's walls, and the extendable air tubes are configured to draw in fresh air from outside and dispense it into the tunnel to ensure breathable air for occupants.

In an embodiment, the emergency escape system further comprises a multiple-entry design, wherein the tunnel has entrances distributed across multiple locations within a building, the system is configured to allow simultaneous deployment of multiple tunnel entrances in response to the detection of the fire or hazardous conditions.

In an embodiment, the emergency escape system further comprises biometric sensors configured to measure the heart rate, oxygen saturation levels, or respiratory rates of occupants while they are being transported through the tunnel, wherein the processor is further configured to detect abnormal vital signs of an occupant during evacuation.

In a further embodiment, the processor is further configured to initiate one or more actions in response to the detected abnormality. The one or more actions include at least one of increasing the speed of a conveyor belt, diverting the occupant to a specialized or safer evacuation route, alerting emergency personnel of the occupant's condition, or deploying first aid equipment within the tunnel to assist the occupant.

In a further embodiment, the tunnel assembly further comprises thermal imaging cameras configured to detect heat levels and monitor smoke concentrations within the tunnel during the evacuation process.

In an embodiment, the emergency escape system further comprises a communication module integrated into the tunnel, wherein the communication module is configured to allow real-time voice communication between occupants of the tunnel and emergency personnel.

In an embodiment, the emergency escape system further comprises weight distribution sensors configured to monitor load inside the tunnel and manage the flow of occupants based on detected weight.

In an embodiment, the emergency escape system further comprises air quality sensors configured to monitor oxygen levels, smoke, and harmful gases inside the tunnel during evacuation, and automatically activates a ventilation system if unsafe levels are detected

In an embodiment, the emergency escape system further comprises an emergency lighting system integrated into the tunnel, wherein the emergency lighting system is configured to provide visual guidance to occupants during evacuation.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a block diagram of an emergency escape system for fire or hazardous conditions, in accordance with an embodiment of the present disclosure.

FIG. 2 illustrates an exemplary scenario diagram of an emergency escape system for fire or hazardous conditions in normal condition, in accordance with an embodiment of the present disclosure.

FIG. 3 illustrates an exemplary scenario diagram with a conveyer belt partially deployed in the emergency escape system of FIG. 2, in accordance with an embodiment of the present disclosure.

FIG. 4 illustrates an exemplary scenario diagram with the conveyer belt completely deployed in the emergency escape system of FIG. 3, in accordance with an embodiment of the present disclosure.

FIG. 5 illustrates an exemplary scenario diagram of an emergency escape system in a deployed condition, in accordance with an embodiment of the present disclosure.

FIG. 6 illustrates an exemplary scenario of an emergency escape system with a fire suppressing cover in a deployed condition, in accordance with an embodiment of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known as one of the ordinary skills in the art. Additionally, memory or other storage, as well as communication components, may be employed in embodiments of the invention.

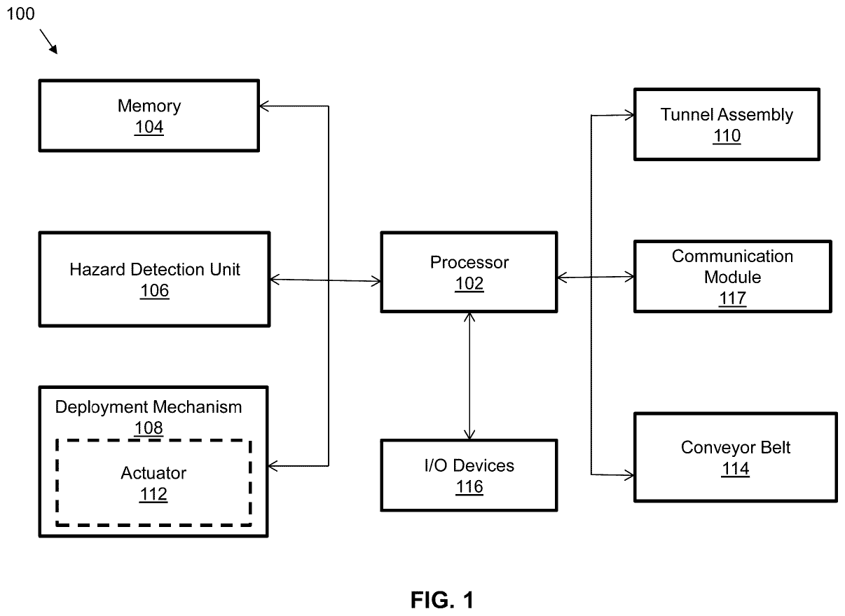

FIG. 1 illustrates a block diagram of an emergency escape system for fire or hazardous conditions, in accordance with an embodiment of the present disclosure. With reference to FIG. 1, there is shown an emergency air escape system 100. The emergency air escape system 100 may include a processor 102, a memory 104, a hazard detection unit 106, a deployment mechanism 108, a tunnel assembly 110, a conveyor belt 114, input/output(I/O) devices 116 and a communication module 117.

The processor 102 coordinates the deployment of the tunnel assembly 110 during hazardous conditions. The processor 102 receives signals from the hazard detection unit 106 and processes them to determine when a fire or hazardous condition is present. Upon receiving such a signal, the processor 102 initiates the activation of the deployment mechanism 108, which unfolds the tunnel assembly 110 from its compact configuration. The processor 102 may also be connected to the memory 104, storing data about hazard thresholds, previous system activations, or instructions for managing the deployment mechanism 108. The processor 102 ensures that the system operates automatically and can activate additional safety measures as needed, such as controlling air quality, detecting abnormal vital signs of an occupant during evacuation, or deploying first aid equipment within the tunnel to assist the occupant.

In a further embodiment, the processor 102 may include suitable logic, circuitry, and interfaces that may be configured to execute program instructions associated with a set of operations to be executed to determine weight distribution, provide the output signal, or control the speaker, the display screen, or the haptic device. The processor 102 may include one or more processing units, which may be implemented as an integrated processor or a cluster of processors that perform the functions of one or more processing units, collectively. The processor 102 may be implemented based on several processor technologies known in the art. Example implementations of the processor 102 may include but are not limited to, an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

In an embodiment, the memory 104 works in conjunction with the processor 102 and stores the operating instructions for the emergency escape system 100. The memory 104 may include critical data such as hazard detection thresholds, deployment protocols, and system status logs. The memory 104 may also store configuration data for the hazard detection unit 106 and historical data on previous activations of the system. This ensures that the processor 102 has access to the necessary information to make informed decisions during emergencies. The memory 104 provides instructions for the controlled unfolding of the tunnel assembly 110 and activation of additional features such as conveyor belts 114.

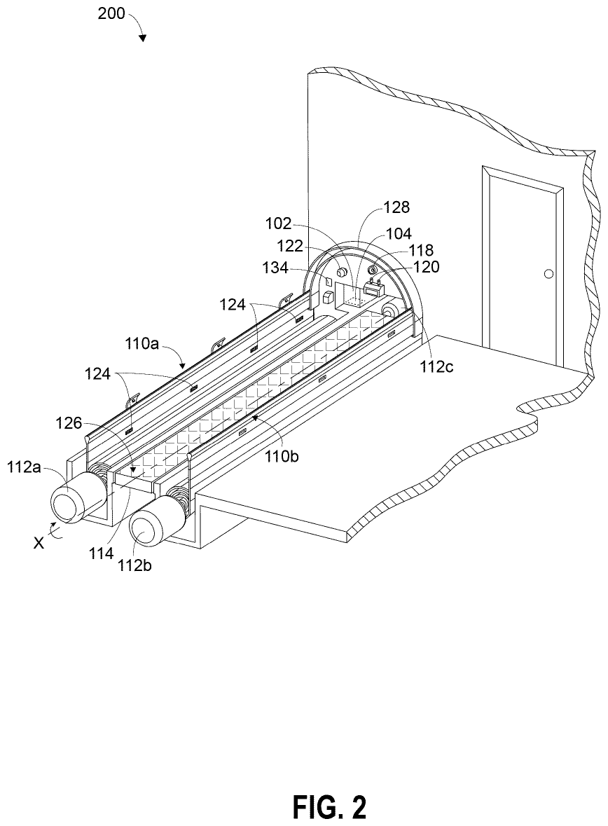

In a further embodiment, the hazard detection unit 106 may detect hazardous conditions such as fire, smoke, heat, or gas. The hazard detection unit 106 may include one or more of sensors 124, detectors 122, or thermal imaging cameras 118 (shown in FIG. 2). The detectors 122 continuously monitor environmental conditions and provide real-time data to the processor 102. Further details of different types of the detectors 122 may be found with reference to description of FIG. 2. When the hazard detection unit 106 detects levels of smoke, heat, or dangerous gases that exceed preset safety thresholds, it sends a signal to the processor 102 to trigger the deployment mechanism 108. This hazard detection unit 106 ensures that the tunnel assembly 110 and the deployment mechanism 108 activate as soon as a hazardous condition is identified, allowing occupants to quickly and safely evacuate the affected area.

In an embodiment, the deployment mechanism 108 may comprise an actuator 112 to unfold the tunnel assembly 110. When the processor 102 sends a signal, the deployment mechanism 108 turns on the actuator 112 and controls how the tunnel segments extend. The deployment mechanism 108 ensures that the tunnel assembly 110 unfolds smoothly and fits properly with the guiding rails 128, thereby creating a safe escape route. The deployment mechanism 108 also has safety features like automatic locks that keep the tunnel securely in place after it is fully deployed, preventing it from collapsing or getting misaligned. In addition to the function of unfolding the tunnel assembly 110, the actuator 112 may also perform the function of deploying the conveyer belt 114 upon detection of the fire or hazardous condition. In an example, the actuator 112 may include rotary actuators 112a, 112b, and 112c such that the pair of rotary actuators 112a and 112b unfold the tunnel assembly 110 while the actuator 112c deploys the conveyer belt upon detection of the fire or hazardous condition. The actuators 112a, 112b, 112c are illustrated in FIG. 2.

In an embodiment, the tunnel assembly 110 is stored in a compact configuration within a recessed cavity beneath the floor during normal conditions. The tunnel assembly 110 may include multiple interlocking tunnel segments 110a and 110b. Upon activation of the deployment mechanism 108, the tunnel assembly 110 unfolds and forms a continuous, protected escape passage from the hazardous environment to a safe location. The tunnel assembly 110 is constructed of fireproof and debris-resistant materials, ensuring the safety of individuals during evacuation. The tunnel assembly 110 is designed to interlock securely as it unfolds, providing structural integrity and resistance to external forces, such as falling debris or heat. The tunnel assembly 110 plays a central role in guiding occupants away from danger and into safety through its robust construction.

In a further embodiment, the actuator 112 may be hydraulic and is responsible for physically deploying the tunnel assembly 110 when triggered by the processor 102. Upon receiving the activation signal, the actuator 112 applies force to push the interlocking tunnel segments outward from the recessed cavity. This force is distributed evenly along the tunnel's guiding rails 128, ensuring a smooth and controlled deployment. The actuator 112 is designed to operate even under adverse conditions, such as power outages or heat, ensuring that the tunnel assembly 110 is deployed reliably during emergencies. Without restricting the scope of the present disclosure, the actuator 112 may alternatively be based on motor driven actuation mechanism.

In an embodiment, inside the tunnel assembly 110, the conveyor belt system 114 is designed to transport occupants from the hazardous environment to a safe location. The conveyor belt 114 is powered by an external motor and is operable to transport both conscious and unconscious individuals. In certain configurations, the conveyor belt 114 includes triangular separators to prevent crowding and ensure that individuals are spaced apart during transport and enables the evacuation of individuals who may be incapacitated or unable to walk, ensuring that everyone is safely transported out of the danger zone. The conveyor belt 114 integrates seamlessly with the tunnel assembly 110 and its unfolding mechanism.

In an embodiment, the input/output devices 116 are designed to facilitate communication and control within the emergency escape system 100. These devices may include control panels, status indicators, and manual override switches for emergency personnel. These devices serve several critical functions that ensure a seamless interaction between users and the emergency escape system. The I/O devices 116 facilitate communication with users. Input devices 116, such as control panels, touch screens or buttons, allow building occupants and emergency personnel to interact with the emergency escape system.

In addition to communication, the I/O devices 116 enable real-time status monitoring of the system. They can display information regarding the operational status of the hazard detection unit 106, deployment mechanism 108, and the conveyor belt 114. This information is crucial for users to assess whether the system is operational and ready for evacuation. Moreover, the I/O devices 116 integrate seamlessly with other system components, interfacing with the processor 102 and memory 104 to facilitate data exchange. For instance, when the hazard detection unit 106 detects a dangerous condition, it communicates with the processor 102 through the I/O devices 116 to initiate the deployment process 108. In conjunction with the deployment mechanism 108, the I/O devices 116 can provide instructions for the sequence of operations, ensuring that the tunnel assembly 110 unfolds correctly and that any additional safety measures, such as fire suppression systems, are activated.

Additionally, the emergency escape system is enabled by a multiple-entry design that strategically places tunnel entrances at various locations within a building, ensuring that occupants have immediate access to an exit in the event of a fire or hazardous condition. This configuration allows the system to respond to detected hazards by simultaneously deploying multiple tunnel entrances, facilitated by an integrated network of actuators 112 and a central processor 102. Upon detection of a fire or hazardous condition, the hazard detection unit 106 communicates with the processor 102, which activates the deployment mechanism to unfold the tunnels at all designated entrances. Each entrance is equipped with control panels that allow for manual activation if necessary, while the automated system ensures that all tunnels open in coordination for optimal evacuation routes. This redundancy enhances safety by reducing potential bottlenecks, enabling quick and efficient egress for building occupants.

In an embodiment, the I/O devices 116 facilitate data logging during emergencies, capturing valuable information about events, such as the time of activation, duration of use, and detected conditions. This data can be analyzed later to improve the system and assess the effectiveness of the evacuation process. Historical data can be stored in the memory 104 and accessed via input devices for system maintenance or updates, ultimately enhancing safety features and preparedness for future emergencies.

In an embodiment, the communication module 117 enables real-time communication between occupants inside the tunnel and emergency personnel. In addition a two-way voice communication process is installed throughout the tunnel, so that occupants can ask for help or get instructions. The module also automatically sends important data, like the number of people in the tunnel, their health status, and conditions like smoke or air quality, to emergency responders.

The communication module 117 may employ various communication protocols, such as Bluetooth, Wi-Fi, NFC (Near Field Communication), Zigbee, or cellular networks (e.g., 3G, 4G, 5G), to transmit data wirelessly. In certain embodiments, the communication module may also support wired communication through interfaces such as USB, Ethernet, or other suitable data transfer methods.

FIG. 2 illustrates an exemplary scenario diagram of an emergency escape system for fire or hazardous conditions in normal conditions, in accordance with an embodiment of the present disclosure. The emergency escape system 100 is depicted in its normal, non-activated state, where the various components are in a compact configuration, ready to be deployed in case of an emergency.

The locking mechanism is a part of deployment mechanism 108 and ensures that the tunnel assembly 110 remains securely folded within its recessed cavity beneath the floor 126 during normal conditions. The locking mechanism keeps the system compact and securely in place, holding the tunnel segments in a stored configuration. The locking mechanism is engaged during non-emergency conditions to prevent unintended deployment. When the system is activated, the locking mechanism disengages, allowing the tunnel to unfold. This feature prevents accidental deployment and ensures that the system is only activated when necessary. The locking mechanism can be automatically triggered by the processor 102 upon detection of hazardous conditions, enabling seamless operation.

Additionally, the tunnel assembly 110 can be deployed from multiple locations within a building, allowing for simultaneous evacuations from different areas. This design is particularly useful in large buildings or complex structures where a single escape route may not suffice. Each tunnel assembly 110 is equipped with its deployment mechanism 108 and hazard detection unit 106, ensuring that all exits can be activated independently or in unison, depending on the situation. The processor 102 coordinates the activation of multiple entries, ensuring that occupants in various parts of the building can evacuate quickly and safely. The use of multiple tunnel assemblies and guiding rails 128 ensures that the system is scalable to different building sizes and layouts.

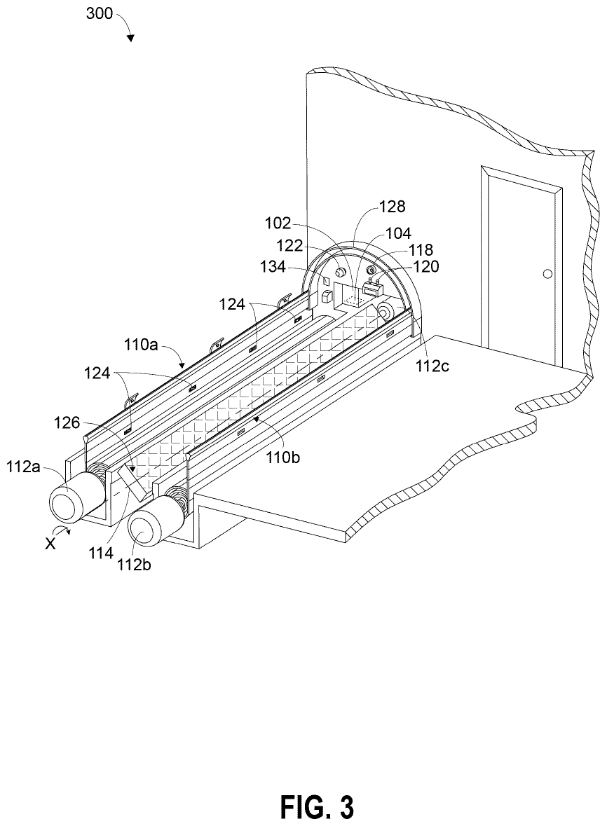

FIG. 3 illustrates an exemplary scenario diagram with a conveyer belt partially deployed in the emergency escape system of FIG. 2, in accordance with an embodiment of the present disclosure. The conveyor belt 114 is stored beneath the floor 126 during normal conditions. Upon activation, the rotary actuators 112c engage to flip the floor 126 downward in a clockwise or anti-clockwise direction, moving the floor 126 from its horizontal position to an open state. As the floor 126 rotates about its axis X, it exposes the conveyor belt 114, allowing it to move into an operational position for evacuation purposes.

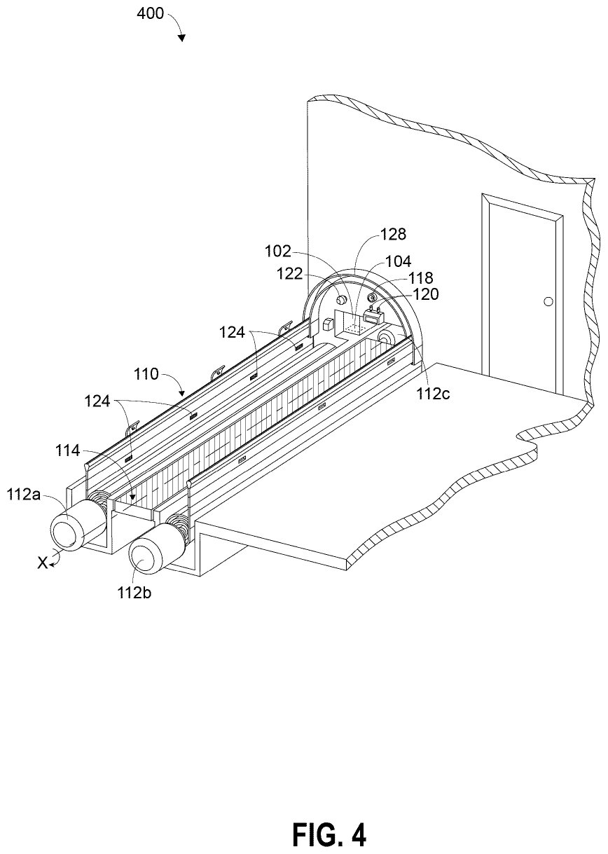

This flip mechanism utilizes the rotary actuator 112c that rotates the floor panel or floor 126 about the axis X, causing the floor to tilt and flip open. Once the floor 126 gets completely flipped or rotates by 180 degrees, the conveyor belt 114 is exposed and ready for transporting individuals during an emergency evacuation which is described further with reference to description of FIG. 4.

FIG. 4 illustrates an exemplary scenario diagram with the conveyer belt completely deployed in the emergency escape system of FIG. 3, in accordance with an embodiment of the present disclosure. Once the actuator 112c completes the rotation of the floor by, for example, 180 degrees, the conveyer belt 114 gets completely exposed for use and transporting occupants from the fire condition to a safe environment. The actuator 112c may be a stepper motor that moves in fixed steps with activation by a controller that supplies currents in pulses, for example, pulse width modulated current pulses. The steps of the actuator or the stepper motors defines the accuracy of the flipping the floor to expose the conveyer belt 114 hidden on another side of the floor. The steps of the stepper motor may be measured as angular rotation of the shaft of the motor in degrees. The processor 102 may control the stepper motor or the actuator 112c to flip the floor by 180 degrees so that the conveyer belt 114 is exposed to transport occupants. The conveyor belt 114 is strategically integrated into the tunnel assembly 110, providing a reliable means of transporting occupants swiftly and safely away from danger. When the emergency escape system 100 is activated due to the detection of hazardous conditions, the conveyor belt 114 deploys alongside the tunnel assembly 110, creating a continuous, smooth pathway that aids in evacuation. It is constructed from fire-resistant materials to withstand extreme temperatures and is designed to support the weight of multiple occupants. Safety features such as side barriers, non-slip surfaces, and emergency stop mechanisms ensure the well-being of evacuees while they are transported. The belt can operate automatically or be manually adjusted through input/output devices 116, enabling occupants or emergency personnel to control its speed and operation according to the evacuation scenario. This configuration not only enhances the efficiency of the escape process but also maintains a high level of safety for all individuals utilizing the system.

The operational functionality of the conveyor belt 114 is directly linked to the processor 102, which controls its deployment and speed, ensuring that the belt is fully functional during emergencies. This capability allows for effective transport of occupants, regardless of their number or the urgency of the situation. The incorporation of fire-resistant materials and structural reinforcements ensures that the conveyor belt can support and protect evacuees while withstanding extreme circumstances. Additionally, the automatic and manual controls integrated into the I/O devices 116 provide redundancy and reliability, allowing for constant operation, even if primary systems fail.

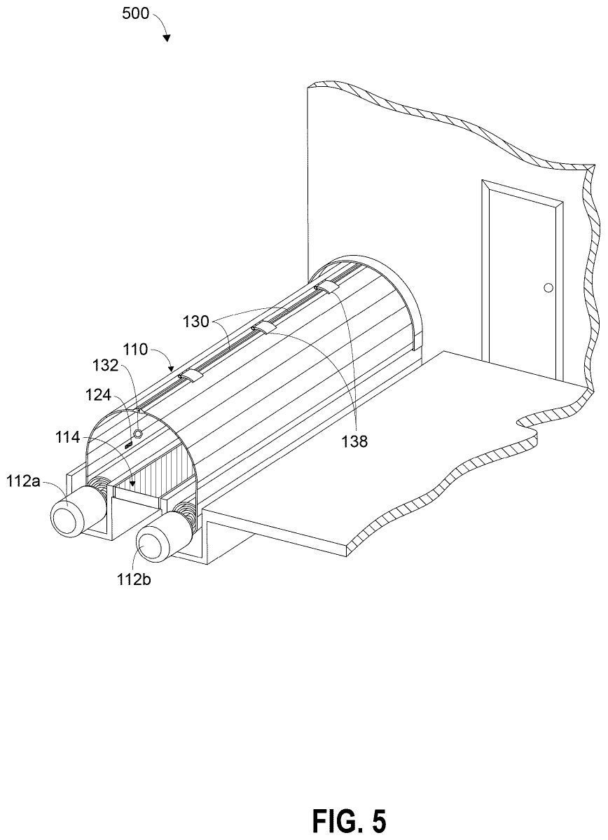

Once the conveyer belt 114 is deployed for transporting occupants to a safe region, the processor 102 may activate the unfolding of the tunnel assembly 110 as further described with reference to description of FIG. 5. The order of deploying the conveyer belt 114 and unfolding of the tunnel assembly 110 may be interchanged.

FIG. 5 illustrates an exemplary scenario diagram of an emergency escape system in a deployed condition, in accordance with an embodiment of the present disclosure. In the deployed condition, the emergency escape system 100 detected a hazardous condition, triggered by the hazard detection unit 106, and completed the deployment of the tunnel assembly 110 and the conveyer belt 114 from beneath the floor. In the deployed state, the emergency escape system 100 is now fully operational, providing a secure escape passage for occupants to evacuate from the dangerous environment to a safe location.

In continuation to the example illustrated in FIG. 4, after the conveyer belt 114 is fully deployed to transport the occupants, the processor 102 activates the pair of actuators 112a and 112b to unfold each segment 110a and 110b of the tunnel assembly 110 which is in folded state from beneath the floor 126. The tunnel assembly 110 is unfolded from its recessed position beneath the floor 126. The tunnel segments 110a and 110b, guided by the rails 128, extend and interlock to form a continuous, secure passage. Constructed with fireproof and debris-resistant materials, the tunnel protects evacuees from heat, flames, and falling debris. The emergency escape system 100 functions seamlessly to create a safe escape route, allowing occupants to evacuate quickly during emergency conditions.

The tunnel assembly 110 may comprise a plurality of interlocking tunnel segments 110a and 110b. These tunnel segments are stored in a folded configuration in normal conditions but are designed to interlock with adjacent segments once deployed. This interlocking mechanism 138 ensures that the tunnel forms a continuous and stable escape passage. Each segment 110a and 110b unfolds from the stored configuration and automatically connects to the adjacent segment, forming a secure tunnel 110. This design is essential to prevent gaps or misalignments between segments, ensuring a safe and effective evacuation route. In FIG. 5, the tunnel assembly 110 is shown in its deployed state, with all segments fully extended and interlocked, providing structural integrity.

The emergency escape system 100 includes intumescent seals 130 strategically placed at the joints between the tunnel segments. These seals are made from graphite-based intumescent material and are highly effective in expanding when exposed to heat, forming a strong barrier against flames, smoke, and heat, effectively forming a barrier that is both airtight and fire-resistant. Additionally expandable polyurethane foam may also be used as an intumescent seal 130, when exposed to high temperatures; it expands and creates a heat-resistant and insulating barrier, making it ideal for preventing the spread of fire. When a hazardous condition, such as a fire, is detected, the heat causes the intumescent seals 130 to swell, filling any gaps between the joints of the tunnel segments. This expansion ensures that smoke, heat, and flames cannot easily pass through, thereby enhancing the safety of occupants using the tunnel during an evacuation. The integration of these seals contributes to the overall integrity of the tunnel assembly 110, ensuring that it remains a secure escape route under emergency conditions. Additionally, the seals are designed to function without requiring any manual operation, automatically activating in response to the heat of a fire, which aligns with the system's objective of providing a safe and effective means of escape during emergencies.

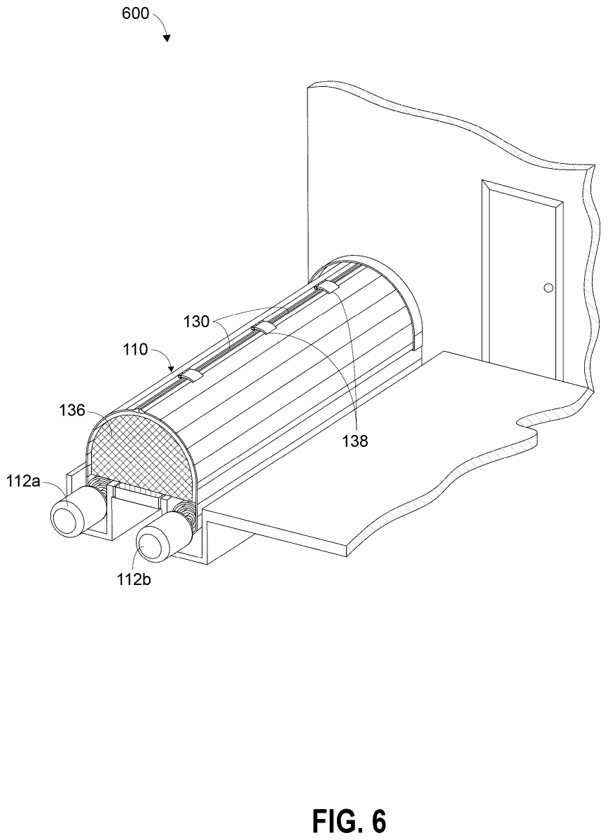

In the tunnel segment, a fire-suppressing cover 136 as shown in FIG. 6 may also be included at the entrance of the tunnel assembly 110. This fire-suppressing cover 136 is designed to extinguish flames on individuals entering the tunnel by isolating the fire from oxygen. The fire-suppressing cover 136 is made of a material that smothers fire, prevents the entry of burning objects, and can automatically deploy when the tunnel unfolds. This fire-suppressing cover 136 may be integrated into the tunnel's entrance, using heat-activated or motion-triggered mechanisms to ensure the cover deploys instantly when a person approaches or enters. The materials used in the cover 136 are flame-retardant and capable of cutting off the oxygen supply to small flames, extinguishing them as evacuees enter.

In the tunnel walls, extendable air tubes 132 are integrated which are designed to provide a continuous supply of breathable air by drawing in fresh air from outside. These air tubes are extendable 132 and function automatically once the tunnel is deployed; ensuring occupants are not suffocated by smoke or hazardous gases inside the tunnel. The system can be powered by an external motor or a battery backup. The extendable air tubes 132 may be made of the material like silicon or neoprene as both are heat and fire resistant.

In an embodiment, the hazard detection unit 106 may comprise sensors 124 to continuously monitor air quality, and the processor 102 controls the activation of the air tubes based on the monitored air quality drops below a predefined threshold.

The sensors 124 may comprise biometric sensors that monitor vital signs such as heart rate, oxygen saturation, and respiratory rates of occupants while they are being transported through the tunnel. These sensors 124 are strategically placed within the tunnel 110, continuously measuring occupant vitals and sending real-time data to the processor 102. The processor 102 may detect any abnormalities in the vital signs and can trigger specific actions such as speeding up the conveyor belt 114 or alerting an emergency personnel.

Additionally, in the emergency escape system 100, various sensors 124 are utilized to enhance safety and efficiency during hazardous conditions. In an embodiment, the hazard detection unit 106 may comprise smoke detectors 122 to identify smoke particles in the air, providing early warnings of potential fires. The sensors 124 of the hazard detection unit 106 may also comprise temperature sensors to detect temperature increases that may indicate a fire and trigger alarms or system deployment, gas sensors to monitor for harmful gases like carbon monoxide, alerting occupants to dangerous air quality, flame sensors that use infrared or ultraviolet radiation to detect flames, offering immediate alerts to fire hazards, or pressure sensors to ensure stability within the tunnel assembly and can identify blockages.

Additionally, the tunnel assembly 110 includes thermal imaging cameras 118 within the tunnel, used to detect heat levels and monitor smoke concentrations during evacuation. These cameras 118 provide real-time data to the processor 102, allowing it to assess the safety of the tunnel environment and determine if any sections are compromised by heat or fire. The thermal imaging cameras 118 work by detecting the infrared radiation emitted by objects and converting it into a visual image, allowing for the monitoring of heat levels and the presence of smoke within the emergency escape system 100. These cameras 118 capture variations in temperature, making them sensitive to even minor changes in heat patterns. The cameras 118 are installed at regular intervals along the tunnel and are connected to the processor 102 for continuous feedback. The thermal imaging cameras 118 are heat-resistant, capable of functioning in high-temperature environments, and properly integrated into the system to monitor conditions throughout the evacuation process.

The fire escape system 100 may also comprise a communication module 117 that is fully integrated into the tunnel assembly 110 and operates seamlessly to ensure effective communication during emergencies. It comprises strategically positioned microphones and speakers along the length of the tunnel at regular intervals, allowing all occupants to communicate clearly, regardless of their location. The microphones and speakers are connected to the main processor 102, which manages communication data and relays it to external personnel. Additionally, the I/O devices 116, such as control panels with dedicated buttons, are placed at key entry and exit points of the tunnel. These panels enable users to initiate communication with emergency responders by simply pressing a button. The control panels remain operational even if the building's main power supply is compromised.

Upon detecting the hazardous condition, the hazard detection unit 106 activates the communication module 117 simultaneously with the deployment of the tunnel assembly 110. This ensures that communication remains available throughout the evacuation process without requiring manual intervention. Occupants inside the tunnel can use the communication system to report their status, request assistance, or provide updates on conditions within the tunnel, such as blockages or additional hazards. Emergency personnel can also use communication module to provide instructions, guide occupants on the safest evacuation route, or inform them of ongoing rescue operations. As a result, the communication module remains functional even in the event of a total power outage or damage to the main building infrastructure, ensuring that evacuees can always communicate with emergency personnel.

The sensors 124 may further include of weight distribution sensors to monitor the load inside the tunnel and manage the flow of evacuees. The sensors 124 may include such weight distribution sensors which are installed along the floor of the tunnel and can detect the weight of individuals passing through, sending real-time data to the processor 102. If the emergency escape system 100 detects overcrowding or uneven distribution of weight that might affect tunnel integrity, it can adjust the flow by slowing or speeding up the conveyor belt 114.

Further, the tunnel assembly 110 involves air quality sensors that monitor oxygen levels, smoke, and harmful gases inside the tunnel during evacuation. The sensors 124 may include such air quality sensors positioned along the length of the tunnel and continuously assess the air quality, automatically activating the ventilation system 134 as shown in FIG. 2 if unsafe levels are detected. This ensures that the air remains breathable for evacuees throughout the tunnel. The air quality sensors are capable of detecting multiple hazardous substances and be integrated with the processor 102 to trigger the ventilation system 134 when needed.

The ventilation system 134 in the tunnel assembly 110 is controlled by air quality sensors 124 that continuously monitor oxygen levels, smoke, and harmful gases. These sensors 124 are placed along the tunnel and detect any hazardous substances. When unsafe air conditions are identified, the sensors 124 send a signal to the processor 102, which automatically activates the ventilation system 134. Fresh air is drawn into the tunnel through extendable air tubes 132, ensuring occupants have breathable air during evacuation.

Additionally, the tunnel assembly 110 comprises an emergency lighting system 120 integrated into the tunnel assembly 110 to provide visual guidance for occupants during evacuation. The emergency light system 120 is installed at regular intervals, powered by an independent energy source, and are activated by the processor 102 once the tunnel assembly 110 is deployed. The lighting system 120 includes backup batteries to ensure it functions even in power outages. The lights guide evacuees toward the exit and can change color or flash to indicate danger.

In an additional embodiment, the emergency escape system 100 makes use of autonomous self-evacuation pods within the tunnel, designed to automatically transport incapacitated individuals to safety. These pods include oxygen supplies, vital sign monitors, and fire-smothering features to protect individuals during transport. The pods are deployed when the system detects an individual is unable to move, using biometric sensors 124, and they autonomously navigate the tunnel, guiding themselves through the tunnel to a safe location. Utilizing advanced navigation technology, the pods autonomously traverse the tunnel, maneuvering around any obstacles they encounter. This self-guided capability not only ensures the safety of the occupant but also optimizes the flow of evacuation by efficiently transporting individuals to designated safe locations.

The autonomous self-evacuation pods use advanced technologies to transport incapacitated individuals safely during emergencies. Biometric sensors 124 monitor vital signs, and when someone is unable to move, the pod is automatically deployed. These pods are equipped with LIDAR or ultrasonic sensors 124 that navigates through the tunnel, avoiding obstacles and following guiding rails or markers. Powered by electric motors with backup batteries, it moves smoothly. The pod is fireproof, with a fire-suppressant system and an oxygen supply, keeping the occupant safe from flames and smoke. It monitors vital signs and allows two-way communication with rescue teams. Upon reaching a safe exit, the pod opens for emergency personnel to assist the individual.

Additionally, the pods are designed with fire-smothering features to protect occupants during transport. These features help to isolate the individual from any flames or smoke, thereby providing a safer environment while they are being moved. Overall, the integration of autonomous self-evacuation pods significantly enhances the emergency escape system 100, ensuring that all occupants, regardless of their physical state, can access a safe exit during emergencies.

The emergency escape system 100 incorporates a communication module 117 within the tunnel assembly 110, allowing real-time voice communication between occupants and emergency personnel during evacuation. It features a surveillance system that monitors the tunnel and surrounding areas, providing real-time feeds to responders for enhanced situational awareness. An air quality monitoring system is integrated to detect harmful gases and maintain safe air conditions for evacuees. Emergency lighting system 120 is included to ensure visibility during low-light conditions or smoke-filled environments. A reinforcement mechanism adds structural support to the tunnel, enhancing its durability and stability. Additionally, a self-cleaning feature minimizes debris and contamination, promoting a safer escape route.

The emergency escape system 100 is a comprehensive safety solution designed to provide occupants with a reliable means of evacuation during hazardous conditions, such as fires or gas leaks. It features a tunnel assembly 110 that can be deployed from a recessed cavity beneath the floor, activated by a processor 102 that responds to signals from various hazard detection units, including smoke, heat, gas, and flame sensors 124. The emergency escape system 100 is equipped with hydraulic actuators 112 for smooth deployment, locking mechanisms to secure the tunnel in its folded state, and intumescent seals 130 that form airtight barriers during emergencies. Additionally, the communication module 117 ensures real-time interaction between occupants and emergency personnel, while the integrated conveyor belt facilitates swift evacuation. Overall, enhances safety, efficiency, and responsiveness in emergency situations, making it an essential feature in modern buildings.

What is claimed is:

1. An emergency escape system for deployment during fire or hazardous conditions, comprising:
a tunnel assembly stored in a compact configuration within a recessed cavity beneath a floor during normal conditions;
a hazard detection unit configured to detect a fire or hazardous condition;
a deployment mechanism configured to unfold and deploy the tunnel assembly from the recessed cavity upon detection of the fire or hazardous condition;
a processor configured to activate the deployment mechanism based on the detection of the fire or hazardous condition, wherein the tunnel assembly, when deployed, forms an escape passage from a hazardous environment to a safe location.

2. The emergency escape system of claim 1, wherein
the tunnel assembly comprises a plurality of interlocking tunnel segments, and
each tunnel segment of the plurality of interlocking tunnel segments is foldable upon itself to form a continuous tunnel when deployed.

3. The emergency escape system of claim 1, wherein the deployment mechanism comprises:
one or more hydraulic actuators configured to push the tunnel segments outward from the recessed cavity; and
guiding rails to control path of the tunnel segments during deployment.

4. The emergency escape system of claim 1, wherein the hazard detection unit comprises a smoke detector or a combination of heat, fire, or gas detectors operable to detect the hazardous conditions and configured to send a signal to the processor to activate the deployment mechanism.

5. The emergency escape system of claim 1, wherein the tunnel assembly includes fireproof and debris-resistant materials, configured to protect individuals from falling debris or heat while they are being transported through the tunnel.

6. The emergency escape system of claim 2, further comprising a conveyor belt system within the tunnel to transport individuals to the safe location, wherein the conveyor belt is powered by an external motor and operable to transport both conscious and unconscious individuals.

7. The emergency escape system of claim 6, wherein the conveyor belt system includes triangular separators to prevent crowding within the tunnel and to control the flow of individuals during evacuation.

8. The emergency escape system of claim 5, further comprising intumescent seals at joints between tunnel segments, the intumescent seals being configured to expand upon exposure to heat, thereby forming an airtight and fire-resistant barrier at the joints.

9. The emergency escape system of claim 2, wherein
the tunnel assembly includes extendable air tubes integrated into the tunnel's walls, and
the extendable air tubes are configured to draw in fresh air from outside and dispense it into the tunnel to ensure breathable air for occupants.

10. The emergency escape system of claim 1, further comprising a multiple-entry design, wherein
the tunnel has entrances distributed across multiple locations within a building, and
the system is configured to allow simultaneous deployment of multiple tunnel entrances in response to the detection of the fire or hazardous conditions.

11. The emergency escape system of claim 2, further comprising
biometric sensors configured to measure heart rate, oxygen saturation levels, or respiratory rates of occupants while they are being transported through the tunnel,
wherein the processor is further configured to detect abnormal vital signs of the occupants during evacuation.

12. The emergency escape system of claim 11, wherein
the processor is further configured to initiate one or more actions in response to the detected abnormality, and
the one or more actions includes at least one of:
increasing speed of a conveyor belt,
diverting the occupants to a specific evacuation route,
alerting emergency personnel of the occupants'condition, or deploying first aid equipment within the tunnel to assist the occupants.

13. The emergency escape system of claim 2, wherein the tunnel assembly includes thermal imaging cameras configured to detect heat levels and monitor smoke concentrations within the tunnel during evacuation process.

14. The emergency escape system of claim 2, further comprising a communication module integrated into the tunnel, wherein the two-way communication system is configured to allow real-time voice communication between occupants of the tunnel and an emergency personnel.

15. The emergency escape system of claim 2, further comprising weight distribution sensors configured to monitor load inside the tunnel and manage the flow of occupants based on detected weight.

16. The emergency escape system of claim 2, further comprising air quality sensors configured to monitor oxygen levels, smoke, and harmful gases inside the tunnel during evacuation, and automatically activating a ventilation system if unsafe levels are detected.

17. The emergency escape system of claim 2, further comprising an emergency lighting system integrated into the tunnel, wherein the emergency lighting system is configured to provide visual guidance to occupants during evacuation.
